(19) United States
(12) Patent Application Publication
(10) Pub. No.: US 2016/0215402 A1
(43) Pub. Date: Jul. 28, 2016

(54) ELECTROLYTIC APPARATUS, ELECTRODE UNIT AND ELECTROLYZED WATER PRODUCTION METHOD

(71) Applicant: KABUSHIKI KAISHA TOSHIBA, Tokyo (JP)

(72) Inventors: Ken TAKAHASHI, Kumagaya Saitama (JP); Masahiro YOKOTA, Fukaya Saitama (JP); Katsuyuki NAITO, Tokyo (JP); Hideo OOTA, Tokyo (JP); Shusuke MORITA, Fukaya Saitama (JP); Hidemi MATSUDA, Toda Saitama (JP); Hisashi CHIGUSA, Yokohama Kanagawa (JP); Wu MEI, Yokohama Kanagawa (JP); Norihiro YOSHINAGA, Kawasaki Kanagawa (JP); Norihiro TOMIMATSU, Mitaka Tokyo (JP); Ryosuke YAGI, Yokohama Kanagawa (JP)

(21) Appl. No.: 15/057,539

(22) Filed: Mar. 1, 2016

Related U.S. Application Data
(63) Continuation of application No. PCT/JP2015/075242, filed on Sep. 4, 2015.

(30) Foreign Application Priority Data
Sep. 19, 2014 (JP) 2014-191567

(51) Int. Cl. C25B 1/46; C02F 1/461; C25B 11/03; C25B 13/04; C25B 13/02; C25B 9/10

(52) U.S. Cl. CPC C25B 1/46; C25B 13/02; C25B 9/10; C25B 11/035; C25B 13/04; C02F 1/461

(57) ABSTRACT

According to one embodiment, an electrolytic apparatus includes a diaphragm of a porous membrane having a water permeability of 0.0024 to 0.6 mL/min per cm² at a differential pressure of 20 kPa, a first electrode provided to oppose the diaphragm, and a second electrode opposing the first electrode via the diaphragm, and the difference between the hydraulic pressures applied onto both sides of the porous membrane is within ±20 kPa.

### CROSS-REFERENCE TO RELATED APPLICATIONS

This application is a Continuation application of PCT Application No. PCT/JP2015/075242, filed Sep. 4, 2015 and based upon and claiming the benefit of priority from Japanese Patent Application No. 2014-191567, filed Sep. 19, 2014, the entire contents of all of which are incorporated herein by reference.

### FIELD

Embodiments described herein relate generally to an electrolytic apparatus, an electrode unit of the electrolytic apparatus and an electrolyzed water production method.

### BACKGROUND

As electrolytic apparatus for producing alkali ion water, ozone water, hypochlorous acidic water or the like, an electrolytic apparatus comprising a three-chamber electrolytic tank (electrolytic cell) is conventionally used. The three-chamber cell includes an electrolytic container divided into three chambers, that is, an anode chamber, an intermediate chamber and a cathode chamber by diaphragms. As the diaphragms, a cation-exchange membrane such as Nafion (trademark) is employed on the cathode side and an anion-exchange membrane containing a quaternary ammonium salt, quaternary phosphonium salt or the like on the anode side. In the anode chamber and the cathode chamber, an anode and a cathode which have a porous structure are provided, respectively.

In such an electrolytic apparatus, for example, a salt water is poured into the intermediate chamber, and water is poured into the cathode chamber and the anode chamber on the right and left sides. Thus, the salt water in the intermediate chamber is electrolyzed by the anode and the cathode to produce hypochlorous acid solution from gaseous chlorine produced in the anode chamber and sodium hydroxide solution in the cathode chamber. Hypochlorous acid thus produced can be utilized as sterilizing solution and sodium hydroxide solution as a cleaning solution.

In such a three-chamber cell, the anion-exchange membrane is deteriorated easily with chlorine or hypochlorous acid. To avoid this, a technology has been proposed, in which a nonwoven fabric with over-wraps and cuts is inserted between the anode of a porous structure prepare by punching or the like and the anion-exchange membrane, to reduce deterioration of the ion-exchange membrane by chlorine. Further, such a technique is also known that a porous membrane is provided so as not to close numerous pores of the electrode.

However, in the electrolytic apparatus having the above-described structure, the deterioration of the nonwoven fabric, and accordingly deterioration of the diaphragms occur after a very long time of operation.

### BRIEF DESCRIPTION OF THE DRAWINGS

FIG. 1 is a cross-sectional view showing an electrolytic apparatus according to a first embodiment.

FIG. 2 is an exploded perspective view showing an electrode unit of the electrolytic apparatus according to the first embodiment.

FIG. 3 is a partially expanded cross-sectional view showing a first electrode and a porous membrane.

FIG. 4 shows results of actual measurement of the amount of water permeation through the porous membrane when various hydraulic differential pressures are applied to the porous membrane.

FIG. 5 is a graph indicating the amount of water permeation when converted into the case where the horizontal axis represents the hydraulic differential pressure applied whereas the vertical axis represents the amount per cm² per minute.

FIG. 6 shows results of actual measurement on the quality of the electrolyzed water produced in the anode chamber using the porous membrane for various hydraulic pressures on the anode chamber and the intermediate chamber.

FIG. 7 is a graph in which the horizontal axis represents the difference in hydraulic pressure between the anode chamber and the intermediate chamber, and the vertical axis represents the effective chlorine concentration.

FIG. 8 is a graph in which the horizontal axis represents the difference in hydraulic pressure between the anode chamber and the intermediate chamber (the hydraulic pressure of salt water—the hydraulic pressure of acidic water) and the vertical axis represents the Na ion concentration.

FIG. 9 is a graph in which the vertical axis represents an index and the horizontal axis represents the difference in hydraulic pressure (that of the intermediate chamber—that of the anode chamber).

FIG. 10 is an expanded sectional view showing the first electrode and the porous membrane of the electrolytic apparatus.

FIG. 11 is another expanded sectional view showing the first electrode and the porous membrane of the electrolytic apparatus.

FIG. 12 is a sectional view briefly showing an electrolytic apparatus according to a second embodiment.

FIG. 13 is a sectional view briefly showing an electrolytic apparatus according to a third embodiment.

FIG. 14 is an exploded perspective view showing an electrode unit of the electrolytic apparatus according to the third embodiment.

### DETAILED DESCRIPTION

Various embodiments will be described hereinafter with reference to the accompanying drawings. In general, according to one embodiment, an electrolytic apparatus comprises a diaphragm consisting of a water-permeable porous membrane having a water permeation per cm² of 0.0024 to 0.6 mL/min at a differential pressure of 20 kPa; a first electrode proposed to oppose the diaphragm; and a second electrode opposing the first electrode via the diaphragm, wherein a difference in hydraulic pressure acting on both sides of the porous membrane is within ±20 kPa.

Throughout the embodiments, common structural members are designated by the same reference symbols, and the explanation therefor will not be repeated. Further, the drawings are schematic diagrams designed to assist the reader to understand the embodiments easily. Thus, there may be sections where the shape, dimensions, ratio, etc. are different from those of the actual devices, but they can be re-designed as needed with reference to the following explanations and publicly known techniques.

### First Embodiment

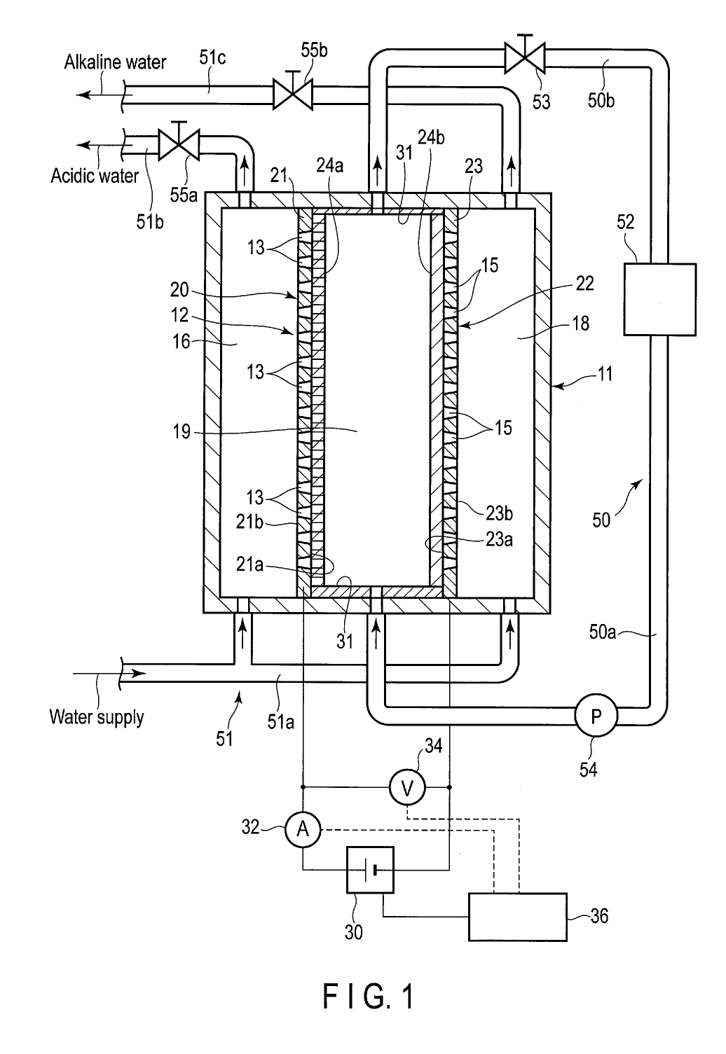

FIG. 1 is a diagram briefly showing an electrolytic apparatus according to the first embodiment. An electrolytic apparatus 10 comprises, for example, a three-chamber electrolytic tank (electrolytic cell) 11. The electrolytic cell 11 is formed into a flat rectangle box, inside which an electrolytic chamber is divided into three compartments by a first diaphragm 24a and a second diaphragm 24b. More specifically, the electrolytic chamber is divided into an anode chamber 16 and an intermediate chamber 19 by the first diaphragm 24a and also the intermediate chamber 19 and a cathode chamber 18 by the second diaphragm 24b. The first diaphragm 24a and the second diaphragm 24b oppose and substantially parallel to each other with a gap therebetween. The electrolytic cell 11 comprises a first electrode (anode) 20 disposed in the anode chamber 16 to oppose the first diaphragm 24a and a second electrode (cathode or counterelectrode) 22 disposed in the cathode chamber 18 to oppose the second diaphragm 24b. Note that a seal member 31 may be provided in upper and lower ends of each of the first and second diaphragms 24a and 24b, respectively, so as to avoid an electrolyte in the intermediate chamber 19 from being brought into direct contact with the first electrode 20 or the second electrode 22. Further, a porous spacer may be provided in the intermediate chamber 19 as a holder to hold the electrolyte.

The electrolytic apparatus 10 comprises a power supply 30 that applies voltage to the first and second electrodes 20 and 22 of the electrolytic cell 11, an ammeter 32, a voltmeter 34 and a control device 36 that controls the members. The anode chamber 16 and the cathode chamber 18 may be each provided with a fluid path for fluid. The electrolytic apparatus 10 comprises an electrolyte supplier 50 which supplies an electrolyte, for example, a saturated solution of sodium chloride (a salt water), to the intermediate chamber 19 of the cell 11 and a water supplier 51 which supplies a solution to be electrolyzed, for example, water, to the anode chamber 16 and the cathode chamber 18.

The electrolyte supplier 50 comprises a salt water tank 52 to produce a saturated solution of sodium chloride (a salt water), a supply pipe 50a which conveys saturated salt water from the salt water tank 52 to a lower portion of the intermediate chamber 19, a liquid feed pump 54 provided in the supply pipe 50a and a liquid discharge pipe 50b which sends the electrolyte which has flowed through the inside of the intermediate chamber 19 from an upper portion of the intermediate chamber 19 to the salt water tank 52. A regulating valve 53 is provided in the liquid discharge pipe 50b.

The water supplier 51 comprises a water supply source (not shown) which supplies water, a water supply pipe 51a which conveys water to lower portions of the anode chamber 16 and the cathode chamber 18 from the water supply source, a first liquid discharge pipe 51b which discharges from the upper portion of the anode chamber 16 the water which has flowed through the anode chamber 16, a second liquid discharge pipe 51c which discharges from the upper portion of the cathode chamber 18 the water which flowed through the cathode chamber 18, a regulating valve (throttle valve) 55a provided in the first liquid discharge pipe 51b and a regulating valve 55b provided in the second liquid discharge pipe 51c.

The hydraulic pressures in the anode chamber 16, the cathode chamber 18 and the intermediate chamber 19 and the differences between these hydraulic pressures can be adjusted by regulating the flow of the liquid feed pump 54 to supply an electrolyte to the intermediate chamber 19, or by adjusting the flow of water or the flow of the electrolyte with regulating valves 53, 55a and 55b.

The operation of the electrolytic apparatus 10 configured as described above, which actually electrolyzes salt water to produce an acidic solution (hypochlorous acid solution and hydrochloric acid) and alkaline water (sodium hydroxide) will now be described.

As shown in FIG. 1, the liquid feed pump 54 is operated to supply saturated salt water to the intermediate chamber 19 of the cell 11, and water to the anode chamber 16 and the cathode chamber 18. At the same time, a positive voltage and a negative voltage are applied to the first electrode 20 and the second electrode 22, respectively, from the power supply 30. Sodium ions electrolytically dissociated in the salt water which has flowed into the intermediate chamber 19 are attracted towards the second electrode 22, pass through the second diaphragm 24b and flow into the cathode chamber 18. Then, in the cathode chamber 18, water is electrolyzed by the second electrode 22 and gaseous hydrogen and an aqueous solution of sodium hydroxide are obtained. The aqueous solution of sodium hydroxide (alkaline water) and gaseous hydrogen thus produced flow out of the cathode chamber 18 into the second liquid discharge pipe 51c, and are discharged through the second liquid discharge pipe 51c.

Meanwhile, chlorine ions electrolytically dissociated in the salt water in the intermediate chamber 19 are attracted towards the first electrode 20, pass through the first diaphragm 24a and flow into the anode chamber 16. Then, the chlorine ions give electrons to the anode with the first electrode 20 to produce gaseous chlorine. After that, the gaseous chlorine reacts with water in the anode chamber 16 to produce hypochlorous acid and hydrochloric acid. The acidic solution thus produced (hypochlorous acidic water and hydrochloric acid) is discharged from the anode chamber 16 through the first liquid discharge pipe 51b.

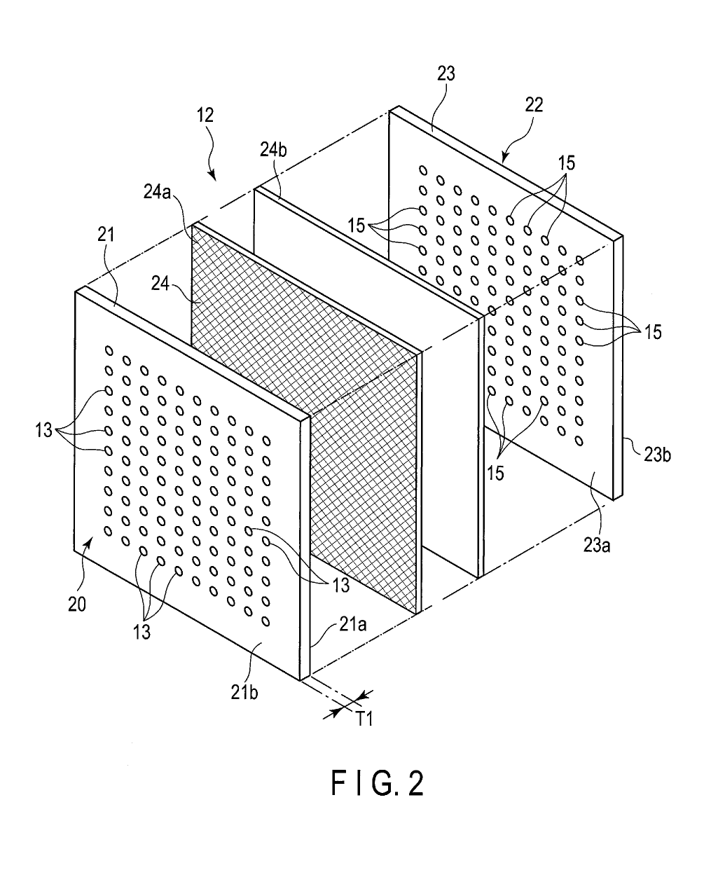

Next, the electrode unit 12 provided in the electrolytic cell 11 will be described in detail. FIG. 2 is an exploded perspective view showing the electrode unit 12. As shown in FIGS. 1 and 2, it is desirable for the electrode unit 12 to comprise the first and second electrodes 20 and 22 and the first and second diaphragms 24a and 24b, described above, and further the seal members 31. Note that the seal members 31 may be provided not on an electrode unit side, but on a cell 11 side.

The first electrode 20 has a porous structure in which, for example, numerous through-holes 13 are formed in a matrix 21 of a metal plate having a rectangular shape. The matrix 21 includes a first surface 21a and a second surface 21b opposing and substantially parallel to the first surface 21a. The gap between the first surface 21a and the second surface 21b, that is, the thickness of the electrode, is T1. The first surface 21a opposes the first diaphragm 24a and the second surface 21b opposes the anode chamber 16.

The through-holes 13 are formed over the entire area in the first electrode 20. The through-holes 13 are opened from the first surface 21a through to the second surface 21b. The through-holes 13 may be each formed to have a tapered or curved inner surface so that the diameter of the opening on the first surface 21a side is larger than that on the second surface 21b side. In this manner, it is possible to reduce the concentration of stress to the first diaphragm 24a, caused by the through-holes 13 of the first electrode 20. The through-holes 13 may have various forms such as rectangular, circular and elliptical. Moreover, the through-holes 13 may not be regularly arranged, but may be at random.

For the matrix 21 of the first electrode 20, a valve metal such as titanium, chromium or aluminum, or an alloy of these, or a conductive metal can be used. It may be desirable, depending on the electrolytic reaction, to form an electrolytic catalyst (catalyst layer) on the first surface 21a and the second surface 21b of the first electrode 20. When used as an anode, it is desirable to use a precious metal catalyst such platinum or an oxide catalyst such as iridium oxide, as the matrix itself of the electrode. The first electrode 20 may be formed so that the quantity of electrolytic catalyst per unit area differs from one surface to the other. Thus, a side reaction and the like can be inhibited; or, by covering the surface (second surface 21b) opposing the first diaphragm 24a of the first electrode 20 with an electrical insulating film, it is possible to reduce the side reaction.

As shown in FIGS. 1 and 2, the second electrode (cathode or counterelectrode) 22 is configured to be similar to the first electrode 20 in this embodiment. More specifically, the second electrode 22 has a porous structure in which numerous through-holes 15 are formed in a matrix 23 of, for example, a rectangular metal plate. The matrix 23 includes a first surface 23a and a second surface 23b opposing and substantially parallel to the first surface 23a. The first surface 23a opposes the second diaphragm 24b and the second surface 23b opposes the cathode chamber 18.

The first diaphragm 24a comprises a water-permeable continuous porous membrane 24. In this embodiment, the porous membrane 24 is formed into, for example, a rectangular shape having a size substantially equal to that of the first electrode 20 and is arranged between the first surface 21a of the first electrode 20 and the first surface 23a of the second electrode 22. The porous membrane 24 is located to oppose the first surface 21a of the first electrode 20, thus covering the entire first surface 21a and the through-holes 13.

As the porous membrane 24, a continuous inorganic oxide porous membrane which contains a chemically stable inorganic oxide is used. Various types of inorganic oxides can be used here, for example, titanium oxide, silicon oxide, aluminum oxide, niobium oxide, tantalum oxide and nickel oxide. Of these, titanium oxide, silicon oxide and aluminum oxide are preferable.

When using the first electrode 20 for the anode, titanium oxide and aluminum oxide are preferable as the inorganic oxide for the porous membrane 24, since these materials easily becomes to have a positive zeta potential in an acidic region and therefore exhibit an anion exchange function. When using for the cathode, as an inorganic oxide of the porous membrane 24, titanium oxide, aluminum oxide and silicon oxide are preferable as the inorganic oxide for the porous membrane 24, since these materials easily becomes to have a negative zeta potential in an alkaline region and therefore exhibit an anion exchange function.

Besides the organic oxides, porous polymers and the like, containing chlorine- or fluorine-based halogenated polymer may be used as well for the porous membrane 24.

The porous membrane 24 has a pore size of 10 to 200 nm and is water-permeable. The porous membrane 24 has a water permeability per cm² of, for example, 0.012 to 0.24 mL/min at a differential pressure of 20 kPa. Further, the hydraulic pressures of the anode chamber 16 and the intermediate chamber 19, which sandwich the porous membrane 24 are set to be approximately equal to each other, and adjusted so that the difference in pressure is within ±6 kPa in terms of hydraulic pressure.

Conventionally, for such a first diaphragm, an anion exchange membrane which is water-impermeable and penetrates only anion is used. But in this embodiment, it was found out that if a water-permeable porous membrane 24 is used at a specific hydraulic differential pressure, electrolyzed water free from excessive electrolyte, which has properties better than that obtained with use of an ion exchange membrane can be produced.

The porous membrane 24 will be described in detail.

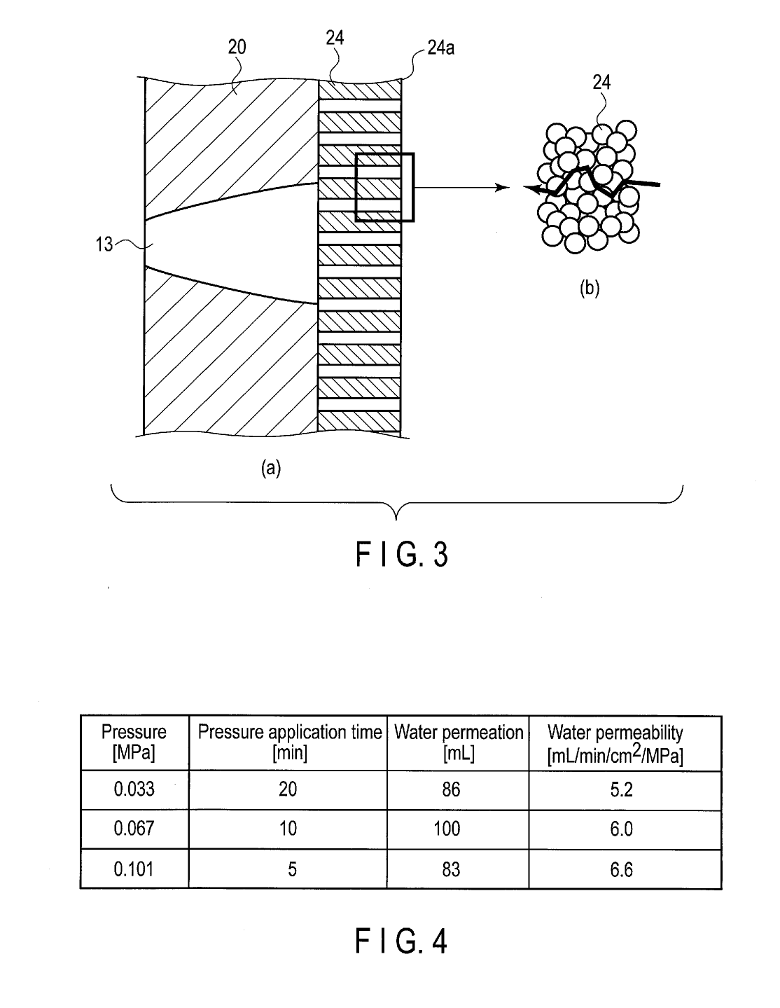

As schematically shown in FIG. 3, the porous membrane 24 is placed to oppose the first surface 21a portion of the first electrode 20, and innumerable small holes with a pore size of around 100 nm are made all over the porous membrane 24. Although FIG. 3(a) schematically illustrates the pores made straight through the membrane in their forms, in reality, the pores are formed in-plane and three-dimensionally irregular in the porous material, as enlarged in FIG. 3(b). Thus, water permeates the porous membrane 24 through complicated courses as indicated by the arrow.

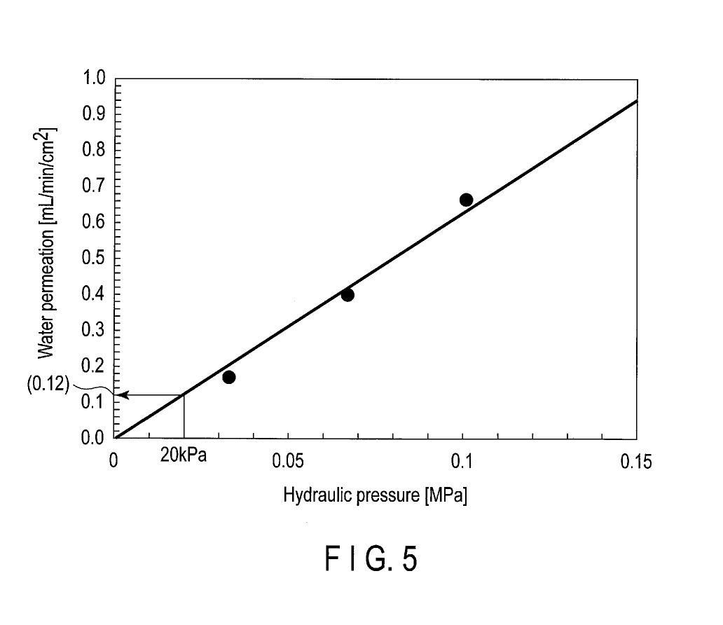

FIG. 4 shows results of actual measurement of the amount of water permeation through the porous membrane 24 when various hydraulic differential pressures are applied to an area of 5 cm×5 cm of the porous membrane 24. For example, it is indicated that the amount of water passed through the porous membrane 24 when apply a hydraulic pressure of 0.033 MPa to an area of 5 cm×5 cm thereof over 20 minutes was 86 mL. Moreover, FIG. 5 shows a graph in which the horizontal axis represents the hydraulic differential pressure applied to the porous membrane (difference between the hydraulic pressures acting on both sides of the porous membrane), whereas the vertical axis represents the water permeation through the porous membrane, converted to that of per minute and per cm².

As shown in FIGS. 4 and 5, the water permeation through the porous membrane 24 increases in direct proportion to the pressure, and the water permeability is 6 mL/min/cm²/MPa, which is, when converted to that when a differential pressure of 20 kPa is applied, equivalent to 0.12 mL/min/cm². It was also confirmed that even if the pore size was changed by specially processing the porous membrane 24 and the water permeability is directly proportional to the pore size. Moreover, the conventional ion exchange membrane does not have such pores as of the porous membrane, but has such a structure that ions pass through gaps between polymers, of 2 nm or less. In the range of the hydraulic pressure and time, shown in FIG. 4, the water permeation is not measurable as a value, which is zero.

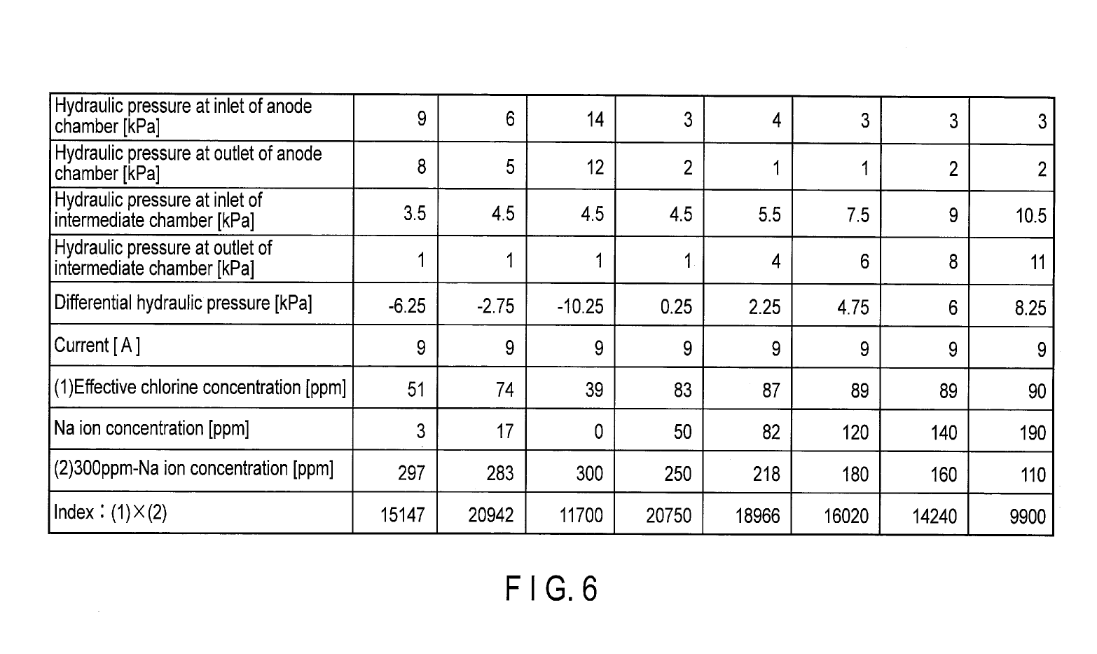

FIG. 6 shows results of actual measurement of the quality of the electrolyzed water produced in the anode chamber 16 at various hydraulic pressures on the anode chamber 16 and the intermediate chamber 19, using this porous membrane 24. Here, salt water was introduced to the intermediate chamber 19 as an electrolyte, and a constant electrolytic current (9 A) was allowed to flow. Thus, gaseous chlorine was produced from the chlorine ions which passed through the porous membrane 24 on the first electrode 20, and gaseous chlorine thus produced reacts with water to produce hypochlorous acid. As the water quality, the effective chlorine concentration of hypochlorous acid used as the index of production efficiency and the salinity concentration (specifically the Na concentration) in the electrolyzed water, which may cause a disadvantage in the water-permeable porous membrane 24 were measured.

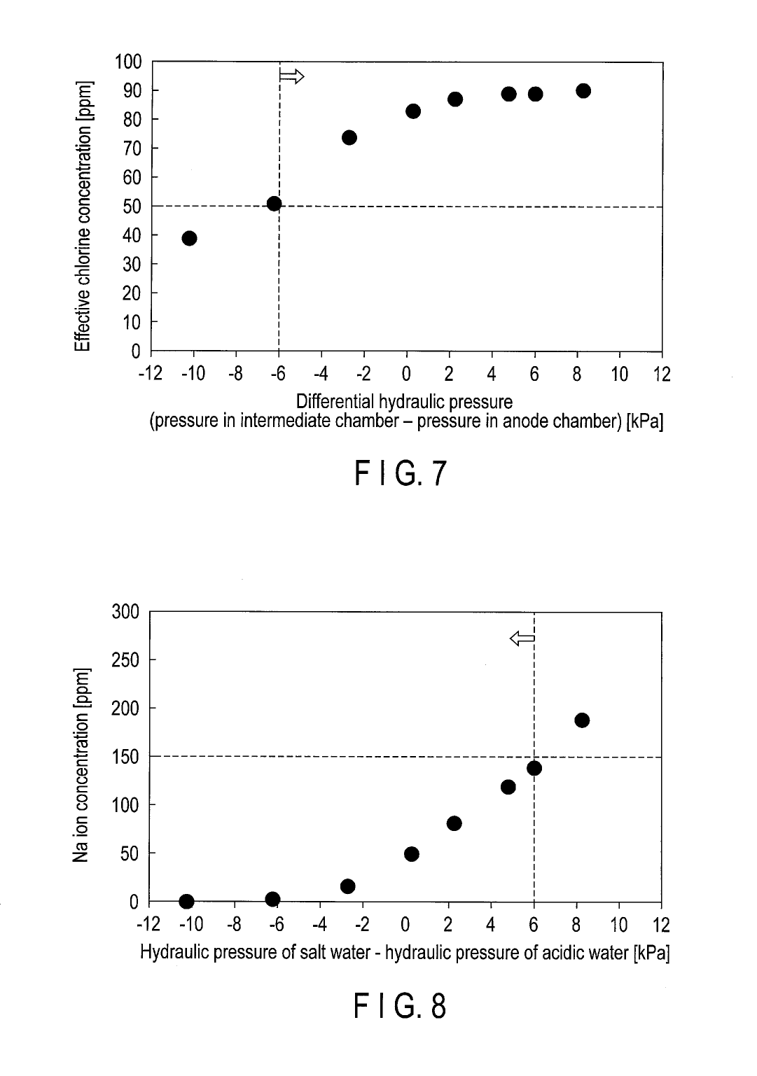

FIGS. 7 and 8 each are a graph in which the horizontal axis represents the difference in hydraulic pressure between the anode chamber and the intermediate chamber, and the vertical axis represents the effective chlorine concentration and the Na ion concentration. Note that, here, the difference in hydraulic pressure is obtained by deducting the average of the hydraulic pressures at the inlet and outlet of the anode from that of the intermediate chamber 19. The hydraulic pressures in the anode chamber 16 and the intermediate chamber 19 and the difference therebetween can be adjusted, by, for example, controlling the liquid feed pump 54 to regulate the supply of the electrolyte to the intermediate chamber 19, or regulating the flow of water with the regulating valves 55a and 55b provided in the first liquid discharge pipe 51b and the second liquid discharge pipe 51c of the anode chamber 16 and the cathode chamber 18.

As shown in FIG. 7, the effective chlorine concentration of the case where an anion exchange membrane of a conventional structure was used as the first diaphragm 24a was about 50 ppm. By contrast, with the porous membrane 24 of this embodiment, a production efficiency higher than the conventional technique was obtained if the hydraulic pressure of the intermediate chamber 19 was higher by −6 kPa than that of the anode chamber 16. This is because the porous membrane 24 itself has water permeability so as to allow chlorine ions pass therethrough much more easily than the conventional anion exchange membrane, and also the number of chlorine ions passing from the intermediate chamber 19 to the anode chamber 16 due to the difference in hydraulic pressure changes so that as the hydraulic pressure of the intermediate chamber 19 is greater, and more chlorine ions penetrate therethrough. The results indicate that as the chlorine ion concentration increases, the competitive oxygen producing reaction is suppressed and the chlorine producing reaction is promoted. In other words, it is understood that with use of the water-permeable porous membrane 24 as the diaphragm and with appropriate setting of the hydraulic pressure conditions (the difference between hydraulic pressures applied to both sides of the porous membrane 24), the production efficiency can be improved as compared to that of the conventional structure.

On the other hand, the porous membrane 24 passes excessive Na ion also, and therefore there is apprehension that salinity mixes in the electrolyzed water produced in the anode chamber 16. As shown in FIG. 8, it was confirmed in this embodiment that when the hydraulic pressure of the intermediate chamber 19 is lower by +6 kPa or less, as compared to that of the anode chamber 16, the Na ion concentration is lower than 150 ppm. The salinity with reference to the tap water is set to 300 ppm and an Na concentration of 150 ppm or less is tap water quality level.

It is conventionally considered that the production efficiency and the mixing of salt content have a relationship of tradeoff as described. That is, in the porous membrane 24 of an anion exchange membrane without ion-selective permeability, when the production efficiency improves if a large number of chlorine ions penetrate from the intermediate chamber 19, but at the same time, sodium ions penetrate and therefore the mixing of salt content increases. However, it has been found here that the relationship is not completely a mutual tradeoff as conventionally considered, but it has a range in which the improvement in production efficiency and the reduction in mixing of salt content are established at the same time within a limited hydraulic pressure condition range as described above.

The indexes are shown in the lowest column of Table shown in FIG. 6. Each index indicates the collective quality obtained between the conflicting items of the production efficiency and the mixing of salt content, which obtained by multiplying: (1) the effective chlorine concentration; and (2) the value obtained by deducting the Na ion concentration from 300 ppm. To explain, as the value of the index is higher, it is shown that production efficiency is higher and the mixing of salt content is lower.

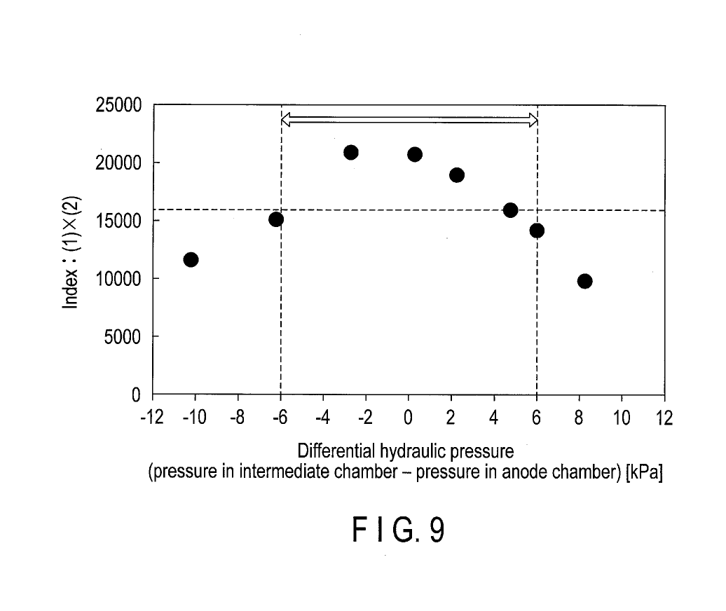

FIG. 9 is a graph in which the vertical axis represents the index and the horizontal axis represents the difference in hydraulic pressure (the hydraulic pressure of the intermediate chamber—that of the anode chamber). The change in the index against the difference in hydraulic pressure does not show a simple increase or decrease, but the index takes a local maximum when the difference in hydraulic pressure is zero. That is, when the difference in hydraulic pressure between the intermediate chamber 19 and the anode chamber 16 is adjusted to zero using the water-permeable first diaphragm 24a, an excellent electrolytic apparatus which cannot be achieved with the conventional structure is realized.

In practice, as the porous membrane 24, a material having a pore size of 10 to 200 nm and a water permeability of 0.6 to 12 mL/min/cm²/MPa (a water permeation of 0.012 to 0.24 mL/min at a hydraulic differential pressure of 20 kPa per cm²) is used, and the difference in hydraulic pressure between the intermediate chamber 19 and the anode chamber 16 (that is, the difference in hydraulic pressure between both sides of the porous membrane 24) is set within a range of ±6 kPa. In this manner, the function of the embodiment can be realized.

Moreover, the values discussed above are those of desirable ranges, and the practical ranges may be set as: a pore size of 2 to 500 nm, a water permeability of 0.12 to 30 mL/min/cm²/MPa (a water permeation of 0.0024 to 0.6 mL/min at a hydraulic differential pressure of 20 kPa per cm²), and a range of the difference in hydraulic pressure between the intermediate chamber 19 and the anode chamber 16 (that is, the hydraulic differential pressure between both sides of the porous membrane 24) of ±20 kPa.

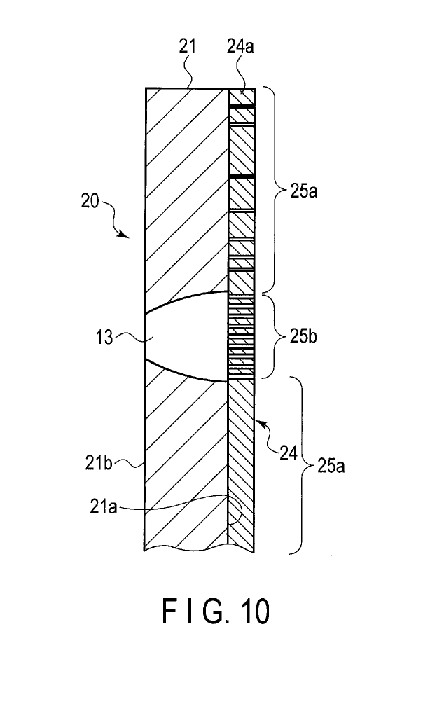

As schematically shown in FIG. 10, the porous membrane 24 comprises a first region 25a opposing the first surface 21a of the first electrode 20, and a second region 25b to cover the opening of each through-hole 13. The first region 25a may be formed to be non-porous. Or the porous membrane 24 may be formed so that the diameter of the pores in the first region 25a is smaller than that in the second region 25b. Or the first region 25a may include a great number of pores whose diameter is substantially the same as those of the second region 25b. Here, the pores are illustrated schematically as those made straight through the membrane, but the membrane form may be porous, and it suffices if the pore diameter and density of the porous membrane 24 differ between the first region 25a and the second region 25b.

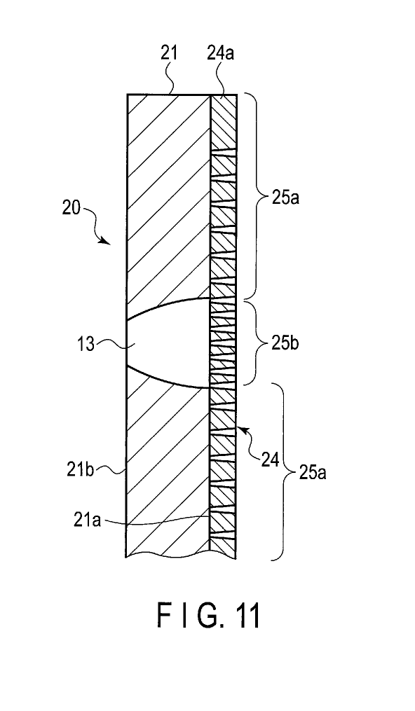

Further, as schematically shown in FIG. 11, as to the pore size of the porous membrane 24, the diameter of the openings on the first electrode 20 side may differ from that of the second electrode 22 side. By adjusting the diameter of the pore openings on the second electrode 22 to be larger than that of the first electrode 20 side, ions can migrate more easily. Furthermore, the porous membrane 24 may have in-plane and three-dimensionally irregular pores. Here, the pores are illustrated schematically, but in reality, it suffices if the porous membrane has such a structure that films having different pore sizes are stacked one on another and the film closest to the first electrode 20 side has pores of smaller size.

The porous membrane 24 may be a multilayer film of a plurality of porous membranes of different pore sizes. In this case, by adjusting the diameter of the pores of a membrane on the second electrode 22 side to be larger than that of a membrane on the first electrode 20 side, ions can migrate more easily, and also the concentration of the stress by the through-holes of the electrode can be reduced.

As shown in FIGS. 1 and 2, the second diaphragm 24b is formed into, for example, a rectangular shape with a size substantially equal to that of the second electrode 22, and also provided to oppose and be adjacent to the first surface 23a of the second electrode 20. Further, the second diaphragm 24b opposes the first diaphragm 24a with a predetermined gap therebetween. As the second diaphragm 24b, the material may be selected from various electrolyte membranes and porous membranes with nano-pores. An example of the electrolyte membranes is a polymer electrolyte membrane, and more specifically, a cation-exchange solid polyelectrolyte membrane, that is, a cation-exchange membrane. Examples of the cation-exchange membrane are NAFION 112, 115 and 117 (E.I. du Pont de Nemours & Co.: trademark), Flemion (Asahi Glass Co., Ltd.: trademark), ACIPLEX (Asahi Chemical Co., Ltd.: trademark) and GOA SELECT (W. L. Goa and associates co.: trademark). Usable examples of the porous membranes with nano-pores are porous ceramics such as porous glass, porous alumina and porous titanium, and porous polymers such as porous polyethylene and porous propylene.

As shown in FIG. 1, in the electrolytic apparatus 10 of the above-described structure, both electrodes of the power supply 30 are electrically connected to the first electrode 20 and the second electrode 22, respectively. The power supply 30 applies voltage to the first and second electrodes 20 and 22 under the control of the control device 36. The voltmeter 34 is electrically connected to the first electrode 20 and the second electrode 22 to detect the voltage applied to the electrolytic cell 11. The detection data is supplied to the control device 36. The ammeter 32 is connected to the voltage applying circuit of the electrolytic cell 11 to detect the electric current flowing through the electrolytic cell 11. The detection data is supplied to the control device 36. The control device 36 controls the application or load of voltage to the electrolytic cell 11 by the power supply 30 based on the detection data according to the program stored in the memory. The electrolytic apparatus 10 applies or loads voltage between the first electrode 20 and the second electrode 22 while the material subjected to the reaction is being supplied to the intermediate chamber 19, the anode chamber 16 and the cathode chamber 18, to make the electrochemical reaction for electrolysis progress.

As to the electrolytic apparatus 10 of this embodiment, it is desirable to electrolyze an electrolyte containing chlorine ion. For example, when the electrolytic apparatus 10 is to produce hypochlorous acid solution, a salt water is poured into the intermediate chamber 19, and water is poured into the anode chambers 16 on both right and left sides and the cathode chamber 18, and thus the salt water of the intermediate chamber 19 is electrolyzed by the first electrode (anode) 20 and the second electrode (cathode) 22. In this manner, hypochlorous acid solution is produced from the gaseous chlorine produced in the anode chamber 16, and sodium hydroxide solution is produced in the cathode chamber 18. The hypochlorous acid solution thus produced is utilized as a bactericidal solution, and the sodium hydroxide solution is utilized as a cleaning solution.

According to the electrolytic apparatus, cell and electrode unit configured as described above, the continuous porous membrane 24 containing a chemically stable inorganic oxide is formed to cover the first surface 21a of the first electrode 20 and the through-holes 13. With this configuration, the distance between the first electrode 20 and the second electrode 22 can be maintained to keep the flow of liquid uniform. Thus, the electrolytic reaction can occur uniformly at the interfaces between electrodes. Because of the uniform electrolytic reaction occurring, the deteriorations of the catalysts and the electrode metals occur uniformly. In addition to this, with use of the chemically stable inorganic oxide, the life of the diaphragms and the cell can be significantly prolonged. Further, since it is possible to make the electrolytic reaction to occur uniformly, the reaction efficiency of the electrolytic apparatus can be improved, and also the deterioration of the electrodes and diaphragms can be inhibited.

The first electrode 20 of a porous structure is formed to have through-holes with a tapered or curved side which enlarges towards the first surface side. With this structure, the contact angle between the opening of each through-hole and the porous membrane 24 is an obtuse angle, thereby making it possible to reduce the concentration of stress on the porous membrane 24.

Further, the first diaphragm 24a is constituted by the porous membrane 24 only, and therefore the device structure is simplified though the ion selectivity may be reduced. Here, the life can be further extended and low-cost production can be realized.

As described above, a long-life electrolytic apparatus which can retain the electrolytic performance for a long time can be.

Note that in the first embodiment, the second electrode 22 has a porous structure with a great number of through-holes, but it is not limited to this. For example, a plate electrode without a through-hole may be employed. Similarly, the first electrode 20 is not limited to a porous structure but may be of a plate shape.

Next, an electrolytic cell and an electrolytic apparatus according to another embodiment will be described. Note that in the other embodiments described below, the same referential symbols are given to the same structural elements as the first embodiment above, and the detailed explanations therefor are omitted. The portions different from those of the first embodiment will be mainly discussed.

### Second Embodiment

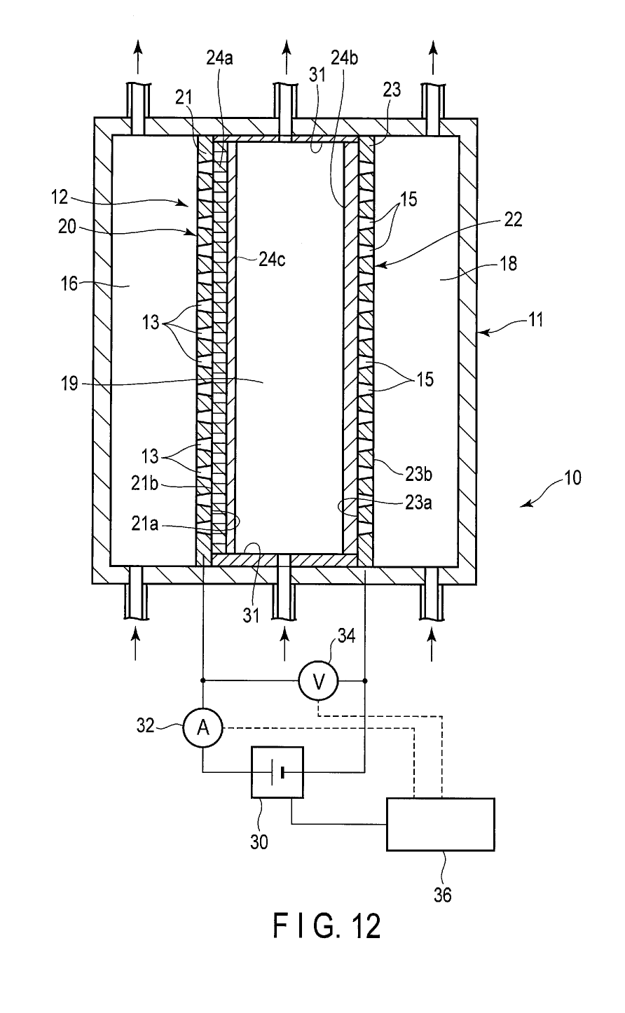

FIG. 12 is a cross-sectional view briefly showing an electrolytic apparatus according to the second embodiment. According to the second embodiment, the first diaphragm 24a comprises a third diaphragm 24c in addition to the porous membrane 24. The third diaphragm 24c is formed on the second electrode 22 side of the porous membrane 24. The third diaphragm 24c is formed into, for example, a rectangular shape of a size substantially equal to that of the first electrode 20, to oppose the entire surface of the porous membrane 24. In this embodiment, the third diaphragm 24c is in contact with the porous membrane 24. Thus, the porous membrane 24, which is the first diaphragm 24a, is interposed between the third diaphragm 24c and the first electrode 20. Further, the third diaphragm 24c opposes and is substantially parallel to the second diaphragm 24b with a predetermined gap therebetween.

As the third diaphragm 24c, a material may be selected from various electrolyte membranes and porous membranes with nano-pores. An example of the electrolyte membranes is a polymer electrolyte membrane, and more specifically, an anion-exchange solid polyelectrolyte membrane, that is, an anion-exchange membrane or a hydrocarbon-based membrane. An example of the anion-exchange membrane is A201 of Tokuyama, Inc. Usable examples of the porous membranes with nano-pores are porous ceramics such as porous glass, porous alumina and porous titanium, and porous polymers such as porous polyethylene and porous propylene. With the third diaphragm 24c described above, the ion selectivity can be improved. Moreover, although an anion-exchange membrane deteriorates easily with gaseous chlorine or the like, it is possible with the structure that the highly durable porous membrane 24 is interposed between itself and the first electrodes 20 to prevent the deterioration of the ion exchange membrane nearly completely. Thus, with the structure that the porous membrane 24, which is the first diaphragm 24a, and the third diaphragm 24c constituted by the anion-exchange membrane are stacked, the electrolytic apparatus 10 with excellent durability and shielding ability to salinity can be realized though the production efficiency may not be increased.

In the second embodiment, the other structure of the electrolytic apparatus 10 is the same as that of the first embodiment described above.

### Third Embodiment

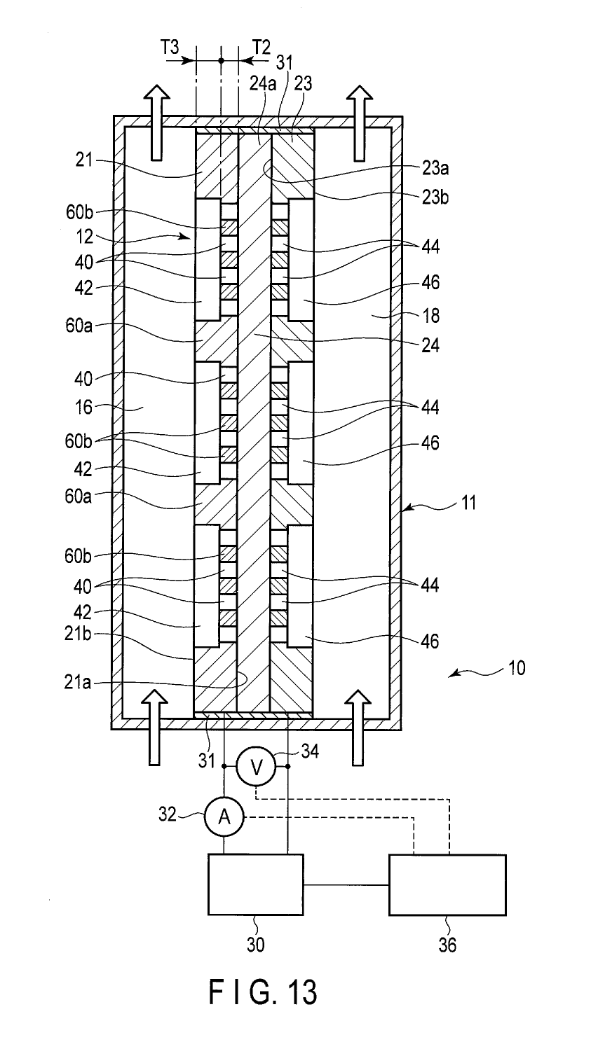

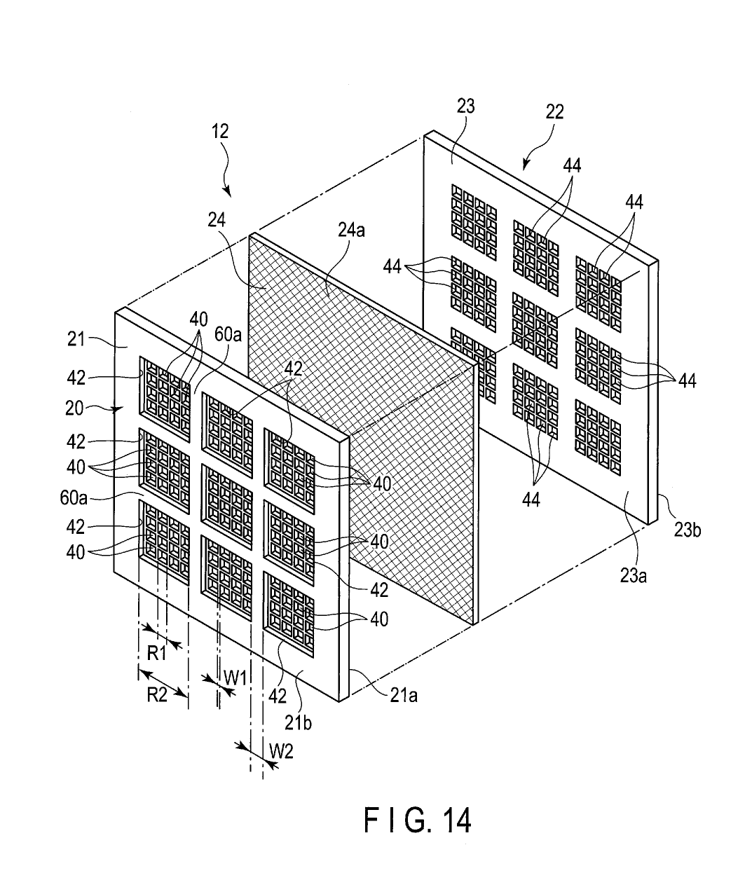

FIG. 13 is a sectional view briefly showing an electrolytic apparatus according to the third embodiment and FIG. 14 is an exploded perspective view of an electrode unit. According to the third embodiment, the electrolytic cell 11 is constituted as a two-chamber type cell, and the first electrode 20 has a porous structure and a mesh structure, with the through-holes having openings, the diameter of which differs from first surface 21a side to the second surface 21b side.

As shown in FIG. 13, the electrolytic cell 11 is formed into a flat rectangle box, inside which an electrolytic chamber is divided by an electrode unit into two compartments, namely, an anode chamber 16 and a cathode chamber 18. The electrode unit comprises a first electrode (anode) 20 located in the anode chamber 16, a second electrode (a counterelectrode or a cathode) 22 located in the cathode chamber 18 and a first diaphragm 24a provided between the first and second electrodes. The first diaphragm 24a is constituted by a porous membrane 24 similar to that of the first embodiment discussed above and the inside of the electrolytic chamber is divided into the anode chamber 16 and the cathode chamber 18 by the first diaphragm 24a. The first electrode 20 and the second electrode 22 oppose each other and the first diaphragm 24a is inserted between the first electrode 20 and the second electrode 22 to be in contact with the first electrode 20 and the second electrode 22.

As shown in FIGS. 13 and 14, the first electrode 20 has a porous structure in which numerous through-holes are formed in a matrix 21 of, for example, a rectangular metal plate. The matrix 21 includes a first surface 21a and a second surface 21b opposing and substantially parallel to the first surface 21a. The first surface 21a opposes the porous membrane 24 and the second surface 21b opposes the anode chamber 16.

A plurality of first holes 40 are formed in the first surface 21a of the matrix 21 to open on the first surface 21a. Moreover, a plurality of second holes 42 are formed in the second surface 21b to open on the second surface 21b. The first holes 40 made on the porous membrane 24 side, have a diameter R1 of the opening, which is smaller than the diameter R2 of the openings of the second holes 42. Further, the first holes 40 are more in number than the second holes 42. The depth of the first holes 40 is T2 and the depth of the second holes 42 is T3. In this embodiment, the holes are made to satisfy: T2<T3.

The second holes 42 are formed into, for example, a rectangular shape to be arranged in a matrix on the second surface 21b. The circumferential wall which defines each second hole 42 may be formed to have a tapered or curved surface so that the diameter enlarges toward the second surface side from the bottom of the hole to the opening. The interval between adjacent second holes 42, that is, the width of a linear portion 60a is set to W2. Note that the second holes 42 are not limited to a rectangular shape, but may take various other forms. Moreover, the second holes 42 may not necessarily be arranged regularly, but may be at random.

The first holes 40 are formed into, for example, a rectangular shape and are arranged in a matrix on the first surface 21a. The wall surface which defines each first hole 40 may be formed to have a tapered or curved surface so that the diameter enlarges toward the first surface 21a from the bottom of the hole to the opening. In this embodiment, a plurality of, for example, sixteen first holes 40 are provided to oppose one second hole 42. The sixteen first holes 40 each are communicated to the second hole 42 and form the through-holes made through the matrix 21 together with the second hole 42. A mesh linear portion 60b is formed between adjacent first holes 40, and the width W1 of the linear portion 60b is set less than the width W2 of the linear portion 60a between the second holes 42. With this structure, the number in density of the first holes 40 in the first surface 21a is sufficiently larger than that of the second holes 42 in the second surface 21b.

Note that the first holes 40 are not limited to a rectangular shape, but may take some other form. Further, the first holes 40 may not necessarily be arranged regularly, but may be at random. Furthermore, all the first holes 40 may not necessarily be communicated with the second holes 42, but there may be some first holes not communicated with a second hole 42.

The porous membrane 24 is formed on the first surface 21a of the first electrode 20 so as to cover the entire surface of the first surface 21a and the first holes 40. The porous membrane 24 employs a porous membrane similar to that of the first embodiment described above.

As shown in FIGS. 13 and 14, according to the second embodiment, the second electrode (a cathode or a counterelectrode) 22 is formed to have a porous structure and a mesh structure as in the case of the first electrode 20. More specifically, the second electrode 22 comprises a matrix 23 of, for example, a rectangular metal plate and the matrix 23 comprises a first surface 23a and a second surface 23b opposing and substantially parallel to the first surface 23a. The first surface 23a opposes the porous membrane 24 and the second surface 23b opposes the cathode chamber 18.

A plurality of first holes 44 are formed in the first surface 23a of the matrix 23 to open on the first surface 23a. Further, a plurality of second holes 46 are formed in the second surface 23b to open on the second surface 23b. These holes are made so that the opening diameter of the first holes 40 made on the first membrane 24a side is larger than that of the second holes 42, the first holes 40 are more in number than the second holes 42, and the depth of the first holes 40 is more than that of the second holes 42.

A plurality of, for example, sixteen first holes 44 are provided to oppose one second hole 46. These nine first holes 44 are each communicated to the second hole 42 and form the through-holes made through the matrix 23 together with the second hole 46. A narrow mesh linear portion is formed between adjacent first holes 44 and a wide mesh and lattice-like linear portion is formed between adjacent second holes 46. The number in density of the first holes 44 in the first surface 23a is sufficiently larger than that of the second holes 46 in the second surface 23b.

The porous membrane 24, which serves as the first diaphragm 24a, is inserted between the first electrode 20 and the second electrode 22 so as to oppose the entire first surface 21a of the first electrode 20 and also the entire first surface 23a of the second electrode 22.

In the third embodiment, the other structure of the electrolytic apparatus 10 is the same as that of the first embodiment described above. It is desirable for the electrolytic apparatus 10 of this embodiment to electrolyze an electrolyte containing chlorine ion.

Also in the third embodiment configured as described above, the deterioration of the diaphragms can be inhibited, and therefore it is possible to realize an electrolytic apparatus with improved reaction efficiency and prolonged life as in the first embodiment.

Next, various examples and comparative example will be described.

### Example 1

As the porous membrane constituting the first diaphragm 24a, Y-9211T of Yuasa Membrane Systems Co. Ltd. was employed, as the second diaphragm 24b on the cathode side, a cation-exchange membrane, Nafion N117 (trademark) of E.I. du Pont de Nemours, was employed, and as the third diaphragm 24c on the cathode side, an anion-exchange membrane, AHA of Astom Co. was used to prepare an electrode unit and an electrolytic cell 11 shown in FIG. 5. As a holder to hold the electrolyte, a 5-mm-thick porous polystyrene material was used. With the electrolytic cell 11, the electrolytic apparatus 10 was manufactured.

The anode chamber 16 and the cathode chamber 18 of the electrolytic cell 11 were each formed from a vinyl-chloride container in which a straight pathway was formed. The control device 36, the power supply 30, the voltmeter 34 and the ammeter 32 were provided. Pipes and a pump for supplying tap water to the anode chamber 16 and the cathode chamber 18 were connected to the electrolytic cell 11. Further, a saturated salt water tank, pipes and a pump for circulating saturated salt water to the holder (porous polystyrene material) of the electrode unit or the intermediate chamber, were connected to the electrolytic cell 11.

Then, the electrolytic apparatus 10 was operated for electrolysis at a voltage of 5.2 V and a current of 25 A. Here, hypochlorous acid solution having an effective chlorine concentration of 60 ppm was produced on the first electrode (anode) 20 side, and sodium hydroxide solution was produced on the second electrode (cathode) 22 side. Even after continuous operation for 2,000 hours, no substantial rise in voltage or change in the quality of produced solution was observed. Thus, a stable electrolytic treatment could be carried out.

### Example 2

An electrolytic apparatus was manufactured in the same manner as in Example 1 except that the third diaphragm 24c on a cathode side was not used. That is, the electrolytic apparatus shown in FIG. 1 was manufactured. With the electrolytic apparatus 10, electrolysis was carried out at a voltage of 4.0 V and a current of 25 A, in which hypochlorous acid solution having an effective chlorine concentration of 60 ppm was produced on the anode side, and sodium hydroxide solution was produced on the cathode side.

As compared to Example 1, the concentration of sodium chloride contained in the hypochlorous acid solution increased by about 0.1%. Even after continuous operation for 3,000 hours, no substantial rise in voltage or change in the quality of produced solution was observed, thus achieving stable operation.

### Comparative Example 1

An electrolytic apparatus 10 was manufactured in the same manner as in Example 1 except that a polypropylene-based nonwoven fabric was employed as the porous membrane 24.

With the electrolytic apparatus 10, electrolysis was carried out at a voltage of 5 V and a current of 25 A, in which hypochlorous acid solution was produced on the anode side, and a sodium hydroxide solution was produced on the cathode side. After continuous operation for 1,000 hours, a significant rise in voltage and a decrease in effective chlorine concentration were observed. Thus, it was found that this device lacks a long-term stability.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the first electrode and the second electrode are not limited to rectangular shapes, but various other forms may be selected. Further, the material of each structural component is not limited to that employed in the embodiments or examples discussed, but various other materials may be selected as needed. The electrolytic cell of the electrode device is not limited to a three-chamber or two-chamber type, but it may as well be applied to single-chamber types or any electrolytic cells with electrodes in general. The electrolytes and product are not limited to salt or hypochlorous acid, but may be developed into various electrolytes and products.

What is claimed is:

1. A electrolytic apparatus comprising:
a diaphragm of a porous membrane having a water permeability of 0.0024 to 0.6 mL/min per 1 cm² at a differential pressure of 20 kPa;
a first electrode provided to oppose the diaphragm; and
a second electrode opposing the first electrode via the diaphragm,
wherein a difference between hydraulic pressures applied on both sides of the porous membrane is within ±20 kPa.

2. The electrolytic apparatus of claim 1, wherein the porous membrane has a water permeability of 0.012 to 0.24 mL/min per 1 cm² at a differential pressure of 20 kPa.

3. The electrolytic apparatus of claim 1, wherein the difference between the hydraulic pressures applied on both sides of the porous membrane is within ±6 kPa.

4. The electrolytic apparatus of claim 1, wherein the difference between the hydraulic pressures applied on both sides of the porous membrane is adjusted to be zero.

5. The electrolytic apparatus of claim 1, wherein the porous membrane has an average pore diameter of 2 to 500 nm.

6. The electrolytic apparatus of claim 1, wherein the porous membrane has an average pore diameter of 10 to 200 nm.

7. The electrolytic apparatus of claim 1, wherein the porous membrane is formed of an inorganic oxide or a halogenated polymer.

8. The electrolytic apparatus of claim 7, wherein the inorganic oxide is at least one selected from titanium oxide, silicon oxide and aluminum oxide.

9. The electrolytic apparatus of claim 1, wherein the porous membrane includes pores formed in-plane and three-dimensionally irregular.

10. The electrolytic apparatus of claim 1, wherein a diameter of the pores of the porous membrane differs from a first electrode side to a second electrode side.

11. The electrolytic apparatus of claim 1, further comprising an electrolytic cell comprising electrolytic chambers divided by the diaphragm.

12. The electrolytic apparatus of claim 1, further comprising an ion-penetrable diaphragm provided in contact with the diaphragm of the porous membrane.

13. The electrolytic apparatus of claim 11, further comprising:
a first diaphragm of the porous membrane, a second diaphragm provided to oppose the first diaphragm with a gap therebetween, and a third diaphragm provided in contact with the first diaphragm and to oppose the second diaphragm with a gap therebetween,
wherein
the electrolytic cell is divided into an anode chamber and an intermediate chamber with the first diaphragm and the third diaphragm, and into the intermediate chamber and the cathode chamber with the second diaphragm, and
the first electrode is provided in the anode chamber and the second electrode is provided in the cathode chamber.

14. The electrolytic apparatus of claim 1, wherein the apparatus is configured to electrolyze an electrolyte containing chlorine ion with the first electrode and the second electrode.

15. An electrode unit comprising:
a diaphragm of a porous membrane having a water permeability of 0.0024 to 0.6 mL/min per 1 cm² at a differential pressure of 20 kPa;
a first electrode provided to oppose the diaphragm; and
a second electrode opposing the first electrode via the diaphragm,
wherein a difference between hydraulic pressures applied on both sides of the porous membrane is within ±20 kPa.

16. The electrode unit of claim 15, wherein the porous membrane has an average pore diameter of 2 to 500 nm.

17. A method of producing electrolyzed water using an electrolytic apparatus comprising a diaphragm of a porous membrane having water permeability, a first electrode provided to oppose the diaphragm, and a second electrode opposing the first electrode via the diaphragm, the method comprising:
supplying an electrolyte liquid containing chlorine ion to a first electrolytic chamber formed between the diaphragm and the second electrode;
supplying water to a second electrolytic chamber separated from the first electrolytic chamber by the diaphragm, in which the first electrode is disposed;
applying a differential pressure of 20 kPa to both sides of the diaphragm to send the chlorine ion in the electrolyte liquid in the first electrolytic chamber to the first electrode through the diaphragm at a water permeation of 0.0024 to 0.6 mL/min per cm²;
applying voltage to the first electrode to electrolyze the electrolyte liquid, thus producing gaseous chlorine; and
producing acidic water from the gaseous chlorine and the water in the second electrolytic chamber.
